(19) United States
(12) Patent Application Publication
(10) Pub. No.: US 2026/0004608 A1
(43) Pub. Date: Jan. 1, 2026

(54) METHOD AND DEVICE FOR DETECTING FACIAL WRINKLES USING DEEP LEARNING-BASED WRINKLE DETECTION MODEL TRAINED ACCORDING TO SEMI-AUTOMATIC LABELING

(71) Applicant: LULULAB INC., Seoul (KR)

(72) Inventors: Semin KIM, Ansan-si (KR); Huisu YOON, Seoul (KR); Jong Ha LEE, Hwaseong-si (KR); Sangwook YOO, Seoul (KR); Yongjoon CHOE, Seoul (KR)

(73) Assignee: LULULAB INC., Seoul (KR)

(21) Appl. No.: 18/993,189

(22) PCT Filed: Jul. 12, 2023
(86) PCT No.: PCT/KR2023/009902

§ 371 Date: Jan. 10, 2025

(30) Foreign Application Priority Data
Jul. 13, 2022 (KR) 10-2022-0086072

(51) Int. Cl. G06V 40/16; G06V 10/30; G06V 10/44; G06V 10/54; G06V 10/764; G06V 10/77; G06V 10/776

(52) U.S. Cl. CPC G06V 40/172; G06V 10/30; G06V 10/443; G06V 10/54; G06V 10/764; G06V 10/7715; G06V 10/776; G06V 40/171

(57) ABSTRACT

Disclosed are a method and device for detecting facial wrinkles using a deep learning-based wrinkle detection model trained according to semi-automatic labeling. The method for detecting facial wrinkles using a deep learning-based wrinkle detection model trained according to semi-automatic labeling comprises the steps of: generating labeling data; using the generated labeling data to train a wrinkle detection model using supervised learning; inputting a user's face image to the wrinkle detection model trained using supervised learning; and obtaining wrinkle detection data corresponding to the face image on the basis of the output of the wrinkle detection model. Therefore, wrinkles on the face can be detected by quickly and accurately obtaining labeling data by generating the labeling data semi-automatically.

### TECHNICAL FIELD

The present disclosure relates to a deep learning-based facial wrinkle detection technology and, more particularly, to a technology that secures a large amount of training data by using semi-automatic labeling and detects facial wrinkles by using a wrinkle detection model trained by using the secured training data.

### BACKGROUND ART

Facial wrinkles have been widely used in various applications such as age prediction and emotion identification. In the field of facial skin analysis, wrinkle detection may be used to measure the skin condition of a user or recommend cosmetics suitable for the skin of an individual.

In recent times, when many people are interested in beauty, various cosmetics and other treatments or procedures are being studied to address facial wrinkles. However, since detecting facial wrinkles is a prerequisite for addressing this facial wrinkle problem, research on detecting facial wrinkles is also actively being conducted.

Among the various studies, the majority has attempted to detect facial wrinkles by using structural features such as connectivity or direction of facial wrinkles, and recent studies have proposed facial wrinkle detection techniques using a Hessian filter or a Gabor filter.

For facial wrinkle detection technique using a Hessian filter, the following research literature exists.
[1] A. F. Frangi, “Three-dimensional model-based analysis of vascular and cardiac images,” Ph. D. dissertation, Univ. Med. Center Utrecht, Utrecht, The Netherlands, 2001.
[2] C.-C. Ng, M. H. Yap, N. Costen, and B. Li, “Automatic wrinkle detection using hybrid Hessian filter,” in Proc. 12th Asian Conf. Comput. Vis., 2014, pp. 609-622.
[3] C.-C. Ng, M. H. Yap, N. Costen, and B. Li, “Wrinkle detection using hessian line tracking,” IEEE Access, vol. 3, pp. 1079-1088, 2015.

Specifically, technique using the Hessian filter uses a Hessian matrix having second-order partial derivatives as its elements, and determines the features of a two-dimensional image by using unique information such as eigenvalues of the Hessian matrix, and performs face detection by modifying the unique information.

For facial wrinkle detection technique using a Gabor filter, the following research literature exists.
[4] O. G. Cula, P. R. A. BargoNkengne, and N. Kollias, “Assessing facial wrinkles: Automatic detection and quantification,” Skin Res. Technol., vol. 19, no. 1, pp. e 243-e251, 2013
[5] N. Batool and R. Chellappa, “Fast detection of facial wrinkles based on gabor features using image morphology and geometric constraints,” Pattern Recognit., vol. 48, no. 3, pp. 642-658, 2015.

Technique using a Gabor filter takes advantage of emphasis on the magnitude and direction of specific frequency components in a corresponding image through convolution using the Gabor filter, which is a linear filter in the form of a Gaussian kernel modulated by a sine function, and the detection of facial wrinkles is accomplished by applying a pre-processing filter or a post-processing filter to the image to which the Gabor filter has been applied.

However, for the aforementioned techniques, there is the problem that they provide detection performance that is valid only in a specific region such as the forehead but do not guarantee uniform detection performance for the entire face, and since filter parameters must be individually fine-tuned for each image to be analyzed in order to improve wrinkle detection performance, it is difficult to guarantee consistent performance for various types of images with different resolutions, brightness, wrinkle thicknesses, etc.

Meanwhile, research on artificial intelligence (AI) has expanded significantly in recent years, and deep learning-based image recognition technology, which is particularly recognized for its performance in the field of image recognition, is attracting attention for detecting facial wrinkles.

However, in order to detect facial wrinkles by using the deep learning-based image recognition technology, a large amount of training data with facial wrinkles labeled must be secured, but labeling facial wrinkles directly takes a lot of time and effort, making it difficult to easily utilize in application fields.

### DISCLOSURE

### Technical Problem

In order to solve the above problems, the objective of the present disclosure is to provide a method and a device for detecting facial wrinkles by using a deep learning-based wrinkle detection model trained according to semi-automatic labeling.

### Technical Solution

An aspect of the present disclosure to accomplish the above objective provides a method, which is performed in a device for detecting facial wrinkles, for detecting facial wrinkles by using a deep learning-based wrinkle detection model trained according to semi-automatic labeling.

The method for detecting facial wrinkles by using a deep learning-based wrinkle detection model trained according to semi-automatic labeling includes: generating labeling data; training a wrinkle detection model through supervised learning by using the generated labeling data; inputting a facial image of a user into the wrinkle detection model trained through the supervised learning; and obtaining wrinkle detection data corresponding to the facial image on the basis of an output of the wrinkle detection model.

The training of the wrinkle detection model through the supervised learning includes: repeatedly performing of inputting a training facial image used as a training data set and a texture map corresponding to the training facial image into the wrinkle detection model; comparing a wrinkle detection image obtained as the output of the wrinkle detection model with the labeling data on the basis of a loss function; and adjusting parameters constituting the wrinkle detection model on the basis of the comparison result while changing the training facial image.

The generating of the labeling data may include: generating the texture map corresponding to the training facial image by using a Gaussian filter; generating a binary mask corresponding to a rough wrinkle-labeled image obtained by primarily pre-labeling wrinkles from the training facial image so as to correspond to the training facial image; removing a non-wrinkle texture from the texture map by using the binary mask; and generating the labeling data by performing adaptive thresholding on a corrected texture map obtained by removing the non-wrinkle texture from the texture map.

The loss function (Loss) is defined according to a mathematical expression below.

$$Loss = 1 - \frac{2 \times {\sum }_{x} {\sum }_{y} {p}_{x , y} \times {g}_{x , y}}{{\sum }_{x} {\sum }_{y} {p}_{x , y}^{2} + {\sum }_{x} {\sum }_{y} {q}_{x , y}^{2}}$$

In the mathematical expression, p_{x,y} may represent a pixel value for an x-coordinate or a y-coordinate of the wrinkle detection image obtained as the output of the wrinkle detection model, g_{x,y} may represent a pixel value for an x-coordinate or a y-coordinate of the labeling data, and a sigma operation may represent a sum of all pixel values for an x-coordinate or a y-coordinate depending on a subscript notation.

The wrinkle detection model may generate an input image by concatenating the training facial image and the texture map corresponding to the training facial image, and output the wrinkle detection image corresponding to the training facial image by receiving the generated input image.

The wrinkle detection model may sequentially pass the input image through a computation layer, a down-sampling layer, and a computation layer multiple times to obtain a deep feature map, sequentially concatenate the obtained deep feature map with intermediate feature maps generated during the multiple passes in reverse order and repeat the process passing through the computation layer to generate a shallow feature map, and output the wrinkle detection image by concatenating the generated shallow feature map with the input image and passing the generated shallow feature map through the computation layer.

The generating of the texture map corresponding to the training facial image by using the Gaussian filter may include generating the texture map T by performing an operation according to a mathematical expression below by using a filtered image I_{G(σ)} obtained by filtering the training facial image through the Gaussian filter and the training facial image I.

$$T ( x , y ) = ( 1 - \frac{I ( x , y )}{1 + {I}_{G ( σ )} ( x , y )} ) \times 255$$

In the mathematical expression, (x,y) may be a pixel coordinate, I(x,y) may be the training facial image, I_{G(σ)} (x,y) may be the filtered image obtained by filtering the training facial image through the Gaussian filter, and 255, which is a variable applied on the basis of an 8-bit image, may be a variable obtained by applying 2 raised to a power of the number of bits constituting a pixel in an image.

### Advantageous Effects

When using the method and the device for detecting facial wrinkles by using a deep learning-based wrinkle detection model trained according to semi-automatic labeling according to the present disclosure as described above, labeling data in which wrinkles are labeled with high accuracy is automatically generated when only a roughly labeled facial wrinkle image is provided, thereby greatly reducing the effort of a user for securing labeling data and generating labeling data with high accuracy.

In addition, instead of directly using a facial image of a user as an input image for a deep learning-based wrinkle detection model, the input image is provided by concatenating the facial image of the user and a texture map, thereby providing a wrinkle detection with higher wrinkle detection performance.

In addition, the wrinkle detection model according to an embodiment of the present disclosure has the advantage of higher wrinkle detection performance compared to existing conventional technologies.

### DESCRIPTION OF DRAWINGS

FIG. 1 is a conceptual drawing of a device for detecting facial wrinkles according to an embodiment.

FIG. 2 is a conceptual drawing of a device for detecting facial wrinkles according to another embodiment.

FIG. 3 is a flowchart illustrating a method for detecting facial wrinkles according to an embodiment.

FIG. 4 is a conceptual drawing for generating labeling data in the method for detecting facial wrinkles according to an embodiment.

FIG. 5 is a conceptual drawing illustrating the structure of a wrinkle detection model according to an embodiment.

FIGS. 6 and 7 are drawings for comparing the performance of the wrinkle detection model according to an embodiment with an existing model.

FIG. 8 is a diagram illustrating the configuration of hardware for the device for detecting facial wrinkles according to an embodiment.

### MODE FOR INVENTION

The present disclosure may have various modifications and embodiments, and specific embodiments are illustrated in the drawings and described in detail in the detailed description. However, this is not intended to limit the present disclosure to a specific embodiment, but should be understood to include all modifications, equivalents or substitutes included in the spirit and technical scope of the present disclosure. In describing each drawing, similar reference numerals are used to refer to similar components.

Terms such as “first”, “second”, “A”, “B”, etc. may be used to describe various components, but such components should not be limited by such terms. The terms are used solely to distinguish one component from another. For example, without exceeding the scope of the present disclosure, the first component may be named the second component, and similarly, the second component may be named the first component. The term “and/or” includes any combination of a plurality of related described items or any one of a plurality of related described items.

When it is mentioned that a component is “connected” or “coupled” to another component, it should be understood that the component may be directly connected or coupled to the another component, but there may be other components present therebetween. On the other hand, when it is mentioned that a component is “directly connected” or “directly coupled” to another component, it should be understood that there are no other components therebetween.

The terminology used in this application is for the purpose of describing particular embodiments only and is not intended to limit the present disclosure. Singular expressions include plural expressions unless the context clearly indicates otherwise. In this application, it should be understood that terms such as “include” or “have” are intended to specify the presence of a feature, number, step, operation, component, part or combination thereof described in the specification, but do not exclude in advance the possibility of the presence or addition of one or more other features, numbers, steps, operations, components, parts or combinations thereof.

Unless otherwise defined, all terms used herein, including technical or scientific terms, have the same meanings as commonly understood by those skilled in the art to which the present disclosure belongs. Terms defined in commonly used dictionaries should be interpreted as having meanings consistent with their meanings in the context of the relevant art, and should not be interpreted in idealized or overly formal sense unless expressly defined in this application.

Hereinafter, preferred embodiments according to the present disclosure will be described in detail with reference to the attached drawings.

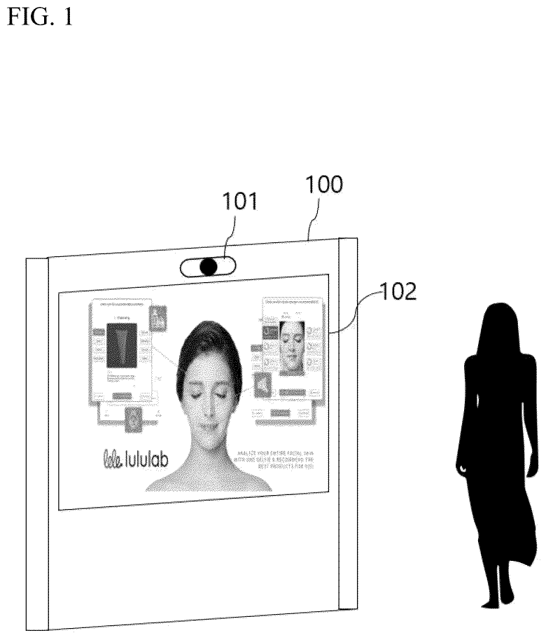

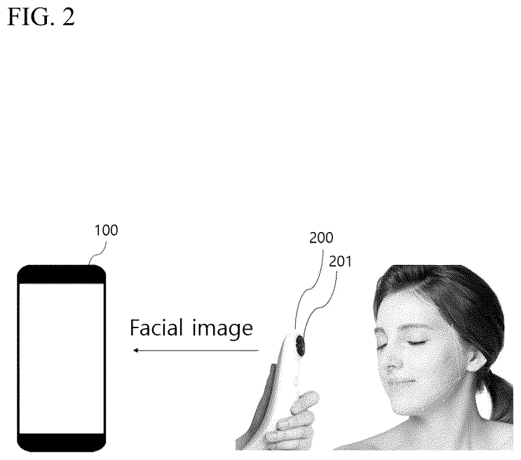

FIG. 1 is a conceptual drawing of a device for detecting facial wrinkles according to an embodiment. FIG. 2 is a conceptual drawing of a device for detecting facial wrinkles according to another embodiment.

Referring to FIG. 1, the device 100 for detecting facial wrinkles according to an embodiment may be a kiosk that is installed on a wall surface or in the form of a free-standing structure.

In an example, the device 100 for detecting facial wrinkles may include a camera 101 that captures the face of a user, and a display unit 102 for displaying skin diagnosis information to a user.

The camera 101 may be installed on front surface of the device 100 for detecting facial wrinkles and may obtain a facial image of a user by photographing the face of the user standing in front of the device 100 for detecting facial wrinkles which is in a kiosk form.

The camera 101 may include a lens unit for transmitting external light to the interior, and the lens unit may be mounted in various types depending on focal length, an aperture (a ratio of lens diameter to the focal length), an angle of view (a width of a captured image), etc. In this case, the camera 101 may include a filter arranged to overlap the lens unit, wherein the filter may be a polarizing filter that selectively transmits light of a specific wavelength (or specific visible light) band.

The display unit 102 may display the skin diagnosis information generated on the basis of the facial image to a user. More specifically, the display unit 102 may display the skin diagnosis s information, which is generated by analyzing the facial image on the basis of artificial intelligence (AI), to a user.

For example, the skin diagnosis information may include information about skin age of a user (or a skin aging level), a skin disease, and skin trouble obtained by analyzing a facial image, skin ranking obtained by comparing skin condition of a user with that of another user, a region requiring skin care, a skin care method suitable for a user, cosmetics suitable for a user, etc.

Meanwhile, the device 100 for detecting facial wrinkles may obtain the images of the scalp or other body parts of a user in addition to the face of the user captured by using the camera 101, and analyze the captured images to generate skin diagnosis information. Accordingly, facial images described below may be applied by being replaced with images taken of other body parts.

Referring to FIG. 2, the device 100 for detecting facial wrinkles according to another embodiment may obtain a facial image of a user by communicating with a small imaging device 200 provided as a separate device by using a wired or wireless network, generate skin diagnosis information by analyzing the obtained facial image, and display the skin diagnosis information to the user.

In this case, the small imaging device 200 may include a camera 201 that performs the same function as the camera 101 described above, and may additionally include a power supply unit (not shown) that supplies power wirelessly (or wiredly in some cases) to the small imaging device 200, a user input unit (not shown) implemented as a physical button or touch display to receive the control input of a user, and a communication module (not shown) for communicating with the device 100 for detecting facial wrinkles by using a wired or wireless network.

That is, the device 100 for detecting facial wrinkles according to another embodiment may be implemented in a form in which the configuration of hardware for acquiring a facial image through the camera 101 in the configuration described with reference to FIG. 1 is implemented as a separate small imaging device 200, and the facial image is acquired through the small imaging device 200. Other operations may be applied as described with reference to FIG. 1 above.

In an example, the device 100 for detecting facial wrinkles may be a desktop computer, a laptop computer, a notebook, a smart phone, a tablet PC, a mobile phone, a smart watch, a smart glass, an e-book reader, a portable multimedia player (PMP), a portable game console, a navigation device, a digital camera, a digital multimedia broadcasting (DMB) player, a digital audio recorder, a digital audio player, a digital video recorder, a digital video player, or a personal digital assistant (PDA), etc. which are capable of communication.

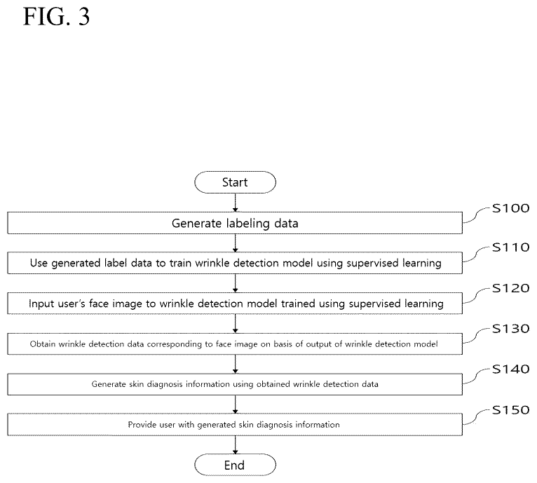

FIG. 3 is a flowchart illustrating a method for detecting facial wrinkles according to an embodiment.

Referring to FIG. 3, the method for detecting facial wrinkles may include generating labeling data in S100, training a wrinkle detection model through supervised learning by using the generated labeling data in S110, inputting a facial image of a user into the wrinkle detection model trained through the supervised learning in S120, obtaining wrinkle detection data corresponding to the facial image on the basis of an output of the wrinkle detection model in S130, generating skin diagnosis information by using the obtained wrinkle detection data the skin diagnosis information in S140, and providing the user with the generated skin diagnosis information in S150.

The method for detecting facial wrinkles according to an embodiment may be performed by the device 100 for detecting facial wrinkles described above. The method may be interpreted as an operation of the device 100 for detecting facial wrinkles.

Labeling data GT may be wrinkle images that label facial wrinkles for each of facial images (which may be referred to as a training data set) captured for multiple users. That is, the labeling data GT is pre-generated to correspond 1:1 to each of the facial images that make up the training data set. The labeling data GT may be generated in different forms for the same training data set depending on the method of labeling facial wrinkles, so the labeling data GT may be referred to as Ground Truth (GT) that is distinguished from a label in the field of deep learning technology to which the present disclosure belongs. However, since the labeling data plays the role of a label in that it is used as an answer sheet for the wrinkle detection model MD, the name of the labeling data GT is used for the convenience of explanation.

The wrinkle detection model MD according to an embodiment of the present disclosure, which is a deep learning-based artificial neural network model, may use a model customized on the basis of U-Net. U-Net, which is an artificial neural network based on a convolutional neural network (CNN), is a model that outputs prediction results by combining the feature maps of a shallow layer obtained through a small number of down-samplings from an input image with feature maps of a deep layer obtained through a large number of down-samplings, and was first proposed in a biomedical field. The structure of U-Net is easily understandable to ordinary technicians, so a detailed description is omitted, and the specific structure of the wrinkle detection model MD is described below.

The training of the wrinkle detection model MD through the supervised learning in S110 may include repeatedly performing of inputting a training facial image used as a training data set and a texture map corresponding to the training facial image into the wrinkle detection model MD, comparing a wrinkle detection image (a predicted output (PO)) obtained as the output of the wrinkle detection model MD with the labeling data GT on the basis of a loss function, and adjusting parameters constituting the wrinkle detection model MD on the basis of the comparison result while changing the training facial image.

Here, the parameters consist of weights and bias, and in one example, a filter of a specific size (e.g., 2×2) composed of weights may be applied to a convolution operation, and the bias may be applied as a correction to the result of the convolution operation.

In an embodiment, the loss function (Loss) may use mean squared error (MSE) and cross-entropy error. Meanwhile, since the number of pixels corresponding to wrinkles in a facial image is relatively very small among pixels constituting an entire facial image, applying the mean squared error or cross-entropy error may cause a data imbalance, and thus the adjusting of parameters using the loss function may not converge quickly.

As a means to quickly and accurately perform the adjusting of parameters due to the aforementioned data imbalance, the loss function according to an embodiment of the present disclosure may be defined as shown in the following Mathematical expression 1.

$$Loss = 1 - \frac{2 \times {\sum }_{x} {\sum }_{y} {p}_{x , y} \times {g}_{x , y}}{{\sum }_{x} {\sum }_{y} {p}_{x , y}^{2} + {\sum }_{x} {\sum }_{y} {q}_{x , y}^{2}} \qquad [ Mathematical expression 1 ]$$

In Mathematical expression 1, p_{x,y} may represent a pixel value for the x-coordinate or y-coordinate of the wrinkle detection image PO obtained as the output of the wrinkle detection model MD, g_{x,y} may represent a pixel value for the x-coordinate or y-coordinate of the labeling data GT, and the sigma operation may represent a sum of all pixel values for the x-coordinate or y-coordinate depending on the subscript notation.

When using the loss function according to Mathematical expression 1, the result of the loss function is output only when wrinkles exist in common at the pixels of the same location of both the wrinkle detection image PO and the labeling data GT, so there is an advantage in that it is possible to perform the parameter adjustment much faster and more accurately.

The adjusting of parameters may include adjusting parameters so that the output value of the loss function is minimized.

Wrinkle detection data corresponding to a facial image may be the wrinkle detection image PO, or may be image data in which facial wrinkles of a user are labeled in the facial image by superimposing the wrinkle detection image PO onto the facial image of the user. However, the wrinkle detection data is not limited thereto, and data generated by processing the wrinkle detection data in various ways, like an image reconstructed by processing the wrinkle detection image PO by applying an image filter to the wrinkle detection image PO or on the basis of the presence or absence of a wrinkle at a specific location in the wrinkle detection image PO may all be interpreted as being included in the present disclosure.

Meanwhile, the skin diagnosis information may include the wrinkle detection data itself as well as information about the skin age of a user (or a skin aging level) described above, a skin disease, skin trouble, skin ranking obtained by comparing skin condition of a user with that of another user, a region requiring skin care, a skin care method suitable for a user, cosmetics suitable for a user, etc.

The inputting of the facial image of a user into the wrinkle detection model trained through supervised learning in S120 may include inputting the facial image of a user and the texture map corresponding to the facial image of a user into the wrinkle detection model trained through supervised learning. That is, by generating the texture map corresponding to the facial image of a user as well as the facial image of a user and inputting the texture map and the facial image as an input image to the wrinkle detection model, just like when performing the supervised learning, the accuracy of wrinkle detection may be improved. In this case, the process of generating the texture map corresponding to the facial image of a user may be interpreted as being identical to the process of generating the texture map corresponding to the training facial image to be described later.

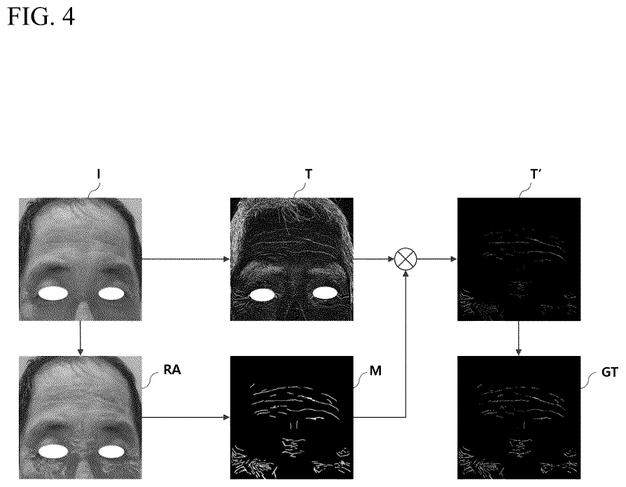

FIG. 4 is a conceptual drawing for generating labeling data in the method for detecting facial wrinkles according to an embodiment.

In the field of a deep learning-based artificial neural network, various methods are being attempted depending on an application field to construct labeling data for training an artificial neural network model through supervised learning. However, in the case of facial wrinkles, since a location and a region recognized as wrinkles vary, a method to increase accuracy is to have a person manually label facial wrinkles to generate the labeling data.

However, it takes a lot of time and effort for a person to manually label facial wrinkles and generate a large amount of labeling data, so minimizing human effort and generating and using labeling data with facial wrinkles labeled automatically with as high accuracy as possible is the method of securing both economy and practicality.

Therefore, according to an embodiment of the present disclosure, a method is provided to secure a large amount of labeling data while sufficiently ensuring the labeling accuracy of facial wrinkles by generating labeling data semi-automatically.

Specifically, the generating of the labeling data in S100 may include generating a texture map T corresponding to a training facial image I by using a Gaussian filter; generating a binary mask corresponding to a rough wrinkle-labeled image RA obtained by primarily pre-labeling wrinkles from the training facial image so as to correspond to the training facial image; removing a non-wrinkle texture from the texture map T by using the binary mask M; and generating the labeling data GT by performing adaptive thresholding on a corrected texture map T′ obtained by removing the non-wrinkle texture from the texture map T. Here, the generating of the labeling data in S100 may be performed for each of training facial images included in a training data set.

The generating of the texture map T corresponding to the training facial image I by using a Gaussian filter may include generating the texture map T by performing an operation according to the following Mathematical expression 2 by using a filtered image I_{G(σ)} obtained by filtering the training facial image I through a Gaussian filter and the training facial image I.

$$T ( x , y ) = ( 1 - \frac{I ( x , y )}{1 + {I}_{G ( σ )} ( x , y )} ) \times 255 \qquad [ Mathematical expression 2 ]$$

In Mathematical expression 2 above, I(x,y) is the training facial image, I_{G(σ)} (x,y) is the filtered image obtained by filtering the training facial image through a Gaussian filter, and it is obvious that the operation according to Mathematical expression 2 is performed on a coordinate (x,y) in the same image. In addition, in Mathematical expression 2, 255 is the result of applying 28 on the basis of an 8-bit image, and in some cases, should be understood as a variable obtained by applying 2 raised to the power of the number of bits constituting a pixel in an image.

In a Gaussian filter, the size of a Gaussian kernel may be 21×21, and the sigma (σ) value of the Gaussian filter may be set to 5, but this is an example, and the size of the Gaussian kernel and the sigma value may be set to be different depending on those skilled in the art. Since the Gaussian filter can be performed by those skilled in the art by applying the size of the Gaussian kernel and the sigma value as parameters, a detailed explanation thereof is omitted.

The rough wrinkle-labeled image RA is not an image in which wrinkles are precisely labeled, but may be an image in which the locations of wrinkles are roughly labeled by a person on the basis of the training facial image I, or an image in which the locations of wrinkles are labeled by those skilled in the art using various other methods (or the easiest and fastest method possible). The rough wrinkle-labeled image RA, together with the training facial image, may be input into the device 100 for detecting facial wrinkles in advance.

The generating of the binary mask M corresponding to the rough wrinkle-labeled image RA may include generating the binary mask M by setting a pixel value corresponding to a position at which wrinkles are labeled and a pixel value corresponding to a position at which wrinkles are not labeled in the rough wrinkle-labeled image RA to a pixel maximum value (e.g., 255 or white) and a pixel minimum value (e.g., 0 or black), respectively.

The removing of the non-wrinkle texture from the texture map T by using the binary mask M may be performed on the basis of the following Mathematical expression 3.

$${T}^{′} ( x , y ) = \{ \begin{matrix}T ( x , y ) , & if M ( x , y ) > 0 \\ 0 , & otherwise\end{matrix} \qquad [ Mathematical expression 3 ]$$

In Mathematical expression 3, M(x,y) may be a pixel value corresponding to a coordinate (x,y) of the binary mask M, T(x,y) may be a pixel value of the texture map T corresponding to the coordinate (x,y), and T′(x,y) may be a pixel value corresponding to a coordinate (x,y) of the corrected texture map.

In the case of an operation of performing adaptive thresholding on the corrected texture map T′, for each area constituting the corrected texture map T′, a threshold value individually calculated is used to change a pixel labeled as a pixel maximum value (or white) to a pixel minimum value (or black), or a pixel labeled as a pixel minimum value (or black) to a pixel maximum value (or white), or for an operation of performing the thresholding while maintaining existing pixel values, a person skilled in the art may apply various adaptive thresholding processes known in the art. For example, see D. Bradley and G. Roth, “Adaptive thresholding using the integral image,” Journal of graphics tools, vol. 12, no. 2, pp. 13-21, 2007.

Referring to FIG. 4, through adaptive thresholding, it can be seen that the wrinkles are more clearly labeled in the corrected texture map T′.

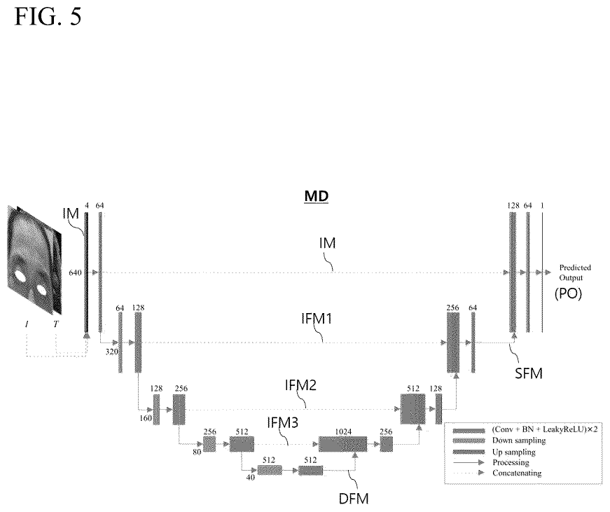

FIG. 5 is a conceptual drawing illustrating the structure of the wrinkle detection model according to an embodiment.

Referring to FIG. 5, the wrinkle detection model MD may be trained through supervised learning by receiving the training facial image I and the texture map T obtained from the training facial image I as input data.

That is, the wrinkle detection model MD generates an input image by concatenating the training facial image I and the texture map T corresponding thereto, and outputs the wrinkle detection image PO by receiving the generated input image and.

In FIG. 5, numbers displayed at the top of each layer represent a channel (also referred to as a depth). For example, the training facial image I may be composed of three channels for each of R, G, and B, and the texture map T may be composed of one channel in grayscale, and an input image composed of four channels formed by concatenating these to each other is input to the wrinkle detection model MD.

In FIG. 5, numbers labeled on the front end of each layer may refer to sizes of a width and a height (or the number of pixels). In FIG. 5, it is assumed that the sizes of the width and height are identical, but this is not limited to such a case, and the sizes may vary.

In FIG. 5, a layer labeled in green is a layer that performs down-sampling (referred to as a down-sampling layer), a layer labeled in blue is a layer that performs up-sampling (referred to as an up-sampling layer), and at least one of the layer that performs down-sampling and the layer that perform up-sampling may be referred to as a pooling layer. In addition, a layer labeled in yellow may be a layer that is repeated twice (referred to as a computational layer) by sequentially concatenating a convolutional layer, a batch normalization layer, and an activation layer. In addition, a layer formed by attaching the layer labeled in yellow and the layer labeled in blue to each other may be a layer that concatenates the output of the computational layer and the output of the up-sampling layer to each other.

In this case, the convolutional layer may be a layer that performs a convolution operation using a filter on an image input to the layer, the batch normalization layer may be a layer that performs batch normalization by using standard deviation and a mean value obtained on the pixel values of an image obtained as the output of the convolutional layer, and the activation layer may be a layer that applies an activation function to the output of the batch normalization layer. In this case, since the convolutional layer, batch normalization layer, and activation layer may be applied by methods known to those skilled in the art, a more detailed description of each layer is omitted.

In an embodiment of the present disclosure, the activation function may be a Leaky ReLU function, but is not limited thereto, and a ReLU function or other known activation functions may be applied as the activation function.

Referring to FIG. 5, the wrinkle detection model MD sequentially may pass an input image through the computation layer, the down-sampling layer, and the computation layer multiple times to obtain a deep feature map (DFM), may sequentially concatenate the obtained deep feature map with intermediate feature maps IFM1, IFM2, and IFM3 generated during the multiple passes in reverse order and repeat the process passing through the computation layer to generate a shallow feature map SFM, and then may output the wrinkle detection image PO by concatenating the generated shallow feature map SFM with the input image IM and passing the generated shallow feature map SFM through the computation layer.

In this case, the intermediate feature maps may include a first intermediate feature map IFM1 obtained by sequentially passing an input image through the computation layer, the down-sampling layer, and the computation layer once, a second intermediate feature map IFM2 obtained by sequentially passing the first intermediate feature map IFM1 through the computation layer, the down-sampling layer, and the computation layer once, and a third intermediate feature map IFM3 obtained by sequentially passing the second intermediate feature map IFM2 through the computation layer, the down-sampling layer, and the computation layer once.

In FIG. 5, it is assumed that the number of repetitions is 4 and three intermediate feature maps are generated, but are not limited thereto, and the number of repetitions may be applied more or less.

Meanwhile, when training the wrinkle detection model MD through supervised learning by using the training facial images used as the training data set and the labeling data, it is required to set a learning rate as a hyperparameter. Typically, the learning rate indicates a degree to which a parameter is adjusted for each run to find parameters that minimize the output of the loss function. When the learning rate is too small, it takes too long to find the parameters that minimize the output of the loss function, and when the learning rate is too large, the output of the loss function increases rather than being minimized, so it is important to set an appropriate learning rate.

To this end, the training of the wrinkle detection model through supervised learning in S110 according to an embodiment of the present disclosure may be performed according to a learning rate to the following Mathematical expression 4.

$${γ}_{t} = {γ}_{min}^{i} + \frac{1}{2} ( {γ}_{max}^{i} - {γ}_{min}^{i} ) ( 1 + cos ( \frac{{T}_{cur}}{{T}_{i}} π ) ) \qquad [ Mathematical expression 4 ]$$

Referring to Mathematical expression 4, γₜ is a learning rate at t-th batch iteration, γⁱₘᵢₙ is a minimum learning rate obtained during the i-th batch iteration, γⁱₘₐₓ is a maximum learning rate obtained during the i-th batch iteration, T_{cur} is the number of epochs processed since the previous restart, and Tᵢ is the number of epochs processed during the i-th batch iteration.

By using a learning rate scheduler that determines a learning rate according to Mathematical expression 4, it is possible to adjust parameters that minimize the loss function most quickly and accurately, thereby ensuring high supervised learning performance.

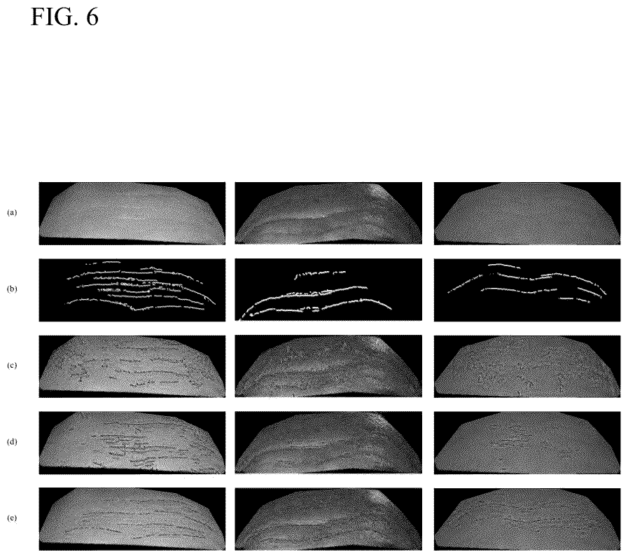

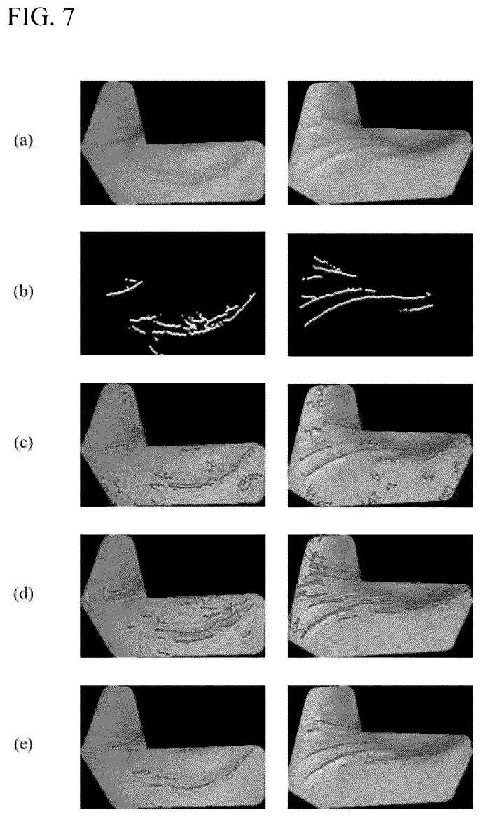

FIGS. 6 and 7 are drawings for comparing the performance of the wrinkle detection model according to an embodiment with an existing model.

Referring to FIG. 6, the data is the result of comparing wrinkle detection performance targeting the forehead portion of a user, and referring to FIG. 7, the data is the result of comparing wrinkle detection performance targeting the eye area of a user.

In FIGS. 6 and 7, a) is an original image captured from a user, (b) is labeling data GT obtained through the process of generating the labeling data described above targeting the original image, (c) is data obtained by detecting wrinkles by applying the Hessian filter, which is a prior art, (d) is data obtained by detecting wrinkles by applying the Gabor filter, which is a prior art, and (e) is wrinkle detection images obtained by using the wrinkle detection model MD trained through supervised learning by using the labeling data GT according to the present disclosure.

To obtain the experimental results of FIGS. 6 and 7, 300 facial images were collected, and 250 facial images among them were used as the training facial images corresponding to the training data set to train the wrinkle detection model MD through supervised learning, and the remaining 50 facial images were used as data for performance verification.

In this case, all facial images were resized to 640×640, and a vertical area between the forehead and an area below the eyes (i.e., an area in which the eyes are located) was cropped and used.

In addition, the size of a Gaussian kernel for applying the Gaussian filter according to the present disclosure was set to 21×21, and the sigma value was set to 5.

To objectively compare the wrinkle detection performance with that of a prior art, a Jaccard similarity index (JSI) was used. The Jaccard similarity index may be an index value calculated by applying the following Mathematical Expression to the wrinkle detection image obtained as a result of wrinkle detection and the labeling data.

$$J ( A , B ) = \vert A ⋂ B \vert / \vert A ⋃ B \vert \qquad [ Mathematical expression 5 ]$$

In Mathematical expression 5, J(A, B) represents the Jaccard similarity index calculated for a wrinkle detection image A and labeling data B, the intersection operation represents the number of pixels commonly detected as wrinkles in the wrinkle detection image A and the labeling data B, and the union operation represents the number of pixels detected as wrinkles in either the wrinkle detection image A or the labeling data B.

Table 1 below compares a case in which the facial image I of a user is used as an input image for the wrinkle detection model MD with a case in which an input image generated by concatenating the facial image I of a user and the texture map T corresponding thereto is used.

TABLE 1

| Input | I | I + T |
|---|---|---|
| JSI | 0.40 | 0.43 |

As shown in Table 1 above, it could be seen that the wrinkle detection model MD proposed in the present disclosure showed slightly higher performance when using an input image generated by concatenating the facial image I of a user and the corresponding texture map T than when performing wrinkle detection by simply using the facial image I of a user as an input image.

In addition, Table 2 shows the results of comparing JSI indices when the forehead according to FIG. 6 was used as the original image and when the eye area according to FIG. 7 was used as the original image.

TABLE 2

| ROI | Hessian | Gabor | Ours |
|---|---|---|---|
| Forehead | 0.17 | 0.14 | 0.47 |
| Eye area | 0.18 | 0.16 | 0.44 |

Referring to Table 2, it can be seen that a JSI index value is measured to be much higher when using the wrinkle detection model MD (ours) trained through supervised learning by using the labeling data GT proposed in the present disclosure than when using the Hessian filter or the Gabor filter, indicating that it is superior in terms of performance.

This is likely due to the fact that, unlike the frequent errors of a Gaussian or Hessian filter incorrectly detecting areas around areas where light is reflected as wrinkles, the wrinkle detection model MD trained with the labeling data GT proposed in the present disclosure makes fewer incorrect detection of the corresponding areas as wrinkles.

In other words, the wrinkle detection model MD proposed in the present disclosure may be explained as having high accuracy, especially compared to other prior art, in detecting wrinkles around an area where light is reflected.

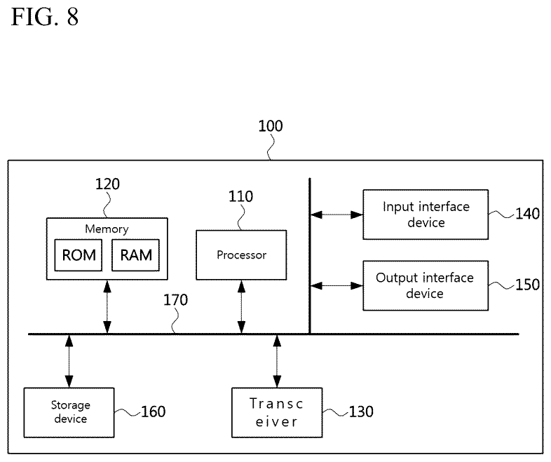

FIG. 8 is a diagram illustrating the configuration of hardware for the device for detecting facial wrinkles according to an embodiment.

Referring to FIG. 8, the device 100 for detecting facial wrinkles may store at least one processor 110 and instructions for instructing the at least one processor 110 to perform at least one operation.

Here, the at least one processor 110 may refer to a central processing unit (CPU), a graphics processing unit (GPU), or a dedicated processor on which methods according to the embodiments of the present disclosure are performed.

The at least one operation may be interpreted as including at least some of the steps according to the method for detecting facial wrinkles described above.

A memory 120 may be configured as at least one of a volatile storage medium and a non-volatile storage medium. For example, the memory 120 may be one of a read only memory (ROM) and a random access memory (RAM).

The device 100 for detecting facial wrinkles may further include a storage device 160 for storing initial data, temporary data, intermediate processing data, processing result data, etc. for processing the at least one operation described above. The storage device 160 may be a flash memory, a hard disk drive (HDD), a solid state drive (SSD), or various memory cards (e.g., a micro SD card), etc.

In addition, the device 100 for detecting facial wrinkles may include a transceiver 130 that performs communication via a wireless network. In addition, the device 100 for detecting facial wrinkles may further include an input interface device 140, an output interface device 150, etc. Each component included in the device 100 for detecting facial wrinkles may be connected to each other by a bus 170 to communicate with each other.

In addition, the device 100 for detecting facial wrinkles may be interpreted as including at least one component described with reference to FIGS. 1 and 2, and a specific description is omitted to avoid redundant description.

The methods according to the present disclosure may be implemented in the form of program instructions that can be executed through various computer means and may be recorded in a computer-readable medium. The computer-readable medium may include program instructions, data files, data structures, etc., either alone or in combination. The program instructions recorded in the computer-readable medium may be specially designed and configured for the present disclosure or may be known and available to those skilled in the art of computer software.

Examples of computer-readable media may include a hardware device specifically configured to store and execute program instructions, such as ROM, RAM, flash memory, and the like. Examples of the program instructions may include high-level language codes that can be executed by a computer by using an interpreter, etc. as well as machine language codes, such as those produced by a compiler. The hardware device described above may be configured to operate with at least one software module to perform the operations of the present disclosure, and vice versa.

In addition, the above-described method or device may be implemented by combining all or part of configuration or function thereof, or may be implemented by separating them.

Although the present disclosure has been described above with reference to preferred embodiments thereof, it will be understood by those skilled in the art that various modifications and changes may be made to the present disclosure without departing from the spirit and scope of the present disclosure as set forth in the claims below.

1. A method, which is performed in a device for detecting facial wrinkles, for detecting facial wrinkles by using a deep learning-based wrinkle detection model trained according to semi-automatic labeling, the method comprising:
generating labeling data;
training a wrinkle detection model through supervised learning by using the generated labeling data;
inputting a facial image of a user into the wrinkle detection model trained through the supervised learning; and
obtaining wrinkle detection data corresponding to the facial image on the basis of an output of the wrinkle detection model,
wherein the training of the wrinkle detection model through the supervised learning comprises:
repeatedly performing of inputting a training facial image used as a training data set and a texture map corresponding to the training facial image into the wrinkle detection model;
comparing a wrinkle detection image obtained as the output of the wrinkle detection model with the labeling data on the basis of a loss function; and
adjusting parameters constituting the wrinkle detection model on the basis of the comparison result while changing the training facial image.

2. The method of claim 1, wherein the generating of the labeling data comprises:
generating the texture map corresponding to the training facial image by using a Gaussian filter;
generating a binary mask corresponding to a rough wrinkle-labeled image obtained by primarily pre-labeling wrinkles from the training facial image so as to correspond to the training facial image;
removing a non-wrinkle texture from the texture map by using the binary mask; and
generating the labeling data by performing adaptive thresholding on a corrected texture map obtained by removing the non-wrinkle texture from the texture map.

3. The method of claim 1, wherein the loss function (Loss) is defined according to a mathematical expression below,
$$Loss = 1 - \frac{2 \times {\sum }_{x} {\sum }_{y} {p}_{x , y} \times {g}_{x , y}}{{\sum }_{x} {\sum }_{y} {p}_{x , y}^{2} + {\sum }_{x} {\sum }_{y} {q}_{x , y}^{2}}$$
and in the mathematical expression, p_{x,y} represents a pixel value for an x-coordinate or a y-coordinate of the wrinkle detection image obtained as the output of the wrinkle detection model, g_{x,y} represents a pixel value for an x-coordinate or a y-coordinate of the labeling data, and a sigma operation represents a sum of all pixel values for an x-coordinate or a y-coordinate depending on a subscript notation.

4. The method of claim 2, wherein the wrinkle detection model generates an input image by concatenating the training facial image and the texture map corresponding to the training facial image, and outputs the wrinkle detection image corresponding to the training facial image by receiving the generated input image.

5. The method of claim 4, wherein the wrinkle detection model sequentially passes the input image through a computation layer, a down-sampling layer, and a computation layer multiple times to obtain a deep feature map,
sequentially concatenates the obtained deep feature map with intermediate feature maps generated during the multiple passes in reverse order and repeats the process passing through the computation layer to generate a shallow feature map, and
outputs the wrinkle detection image by concatenating the generated shallow feature map with the input image and passing the generated shallow feature map through the computation layer.

6. The method of claim 2, wherein the generating of the texture map corresponding to the training facial image by using the Gaussian filter comprises generating the texture map (T) by performing an operation according to a mathematical expression below by using a filtered image (I_{G(σ)}) obtained by filtering the training facial image through the Gaussian filter and the training facial image (I),
$$T ( x , y ) = ( 1 - \frac{I ( x , y )}{1 + {I}_{G ( σ )} ( x , y )} ) \times 255$$
and in the mathematical expression, (x,y) is a pixel coordinate, I(x,y) is the training facial image, I_{G(σ)} (x,y) is the filtered image obtained by filtering the training facial image through the Gaussian filter, and 255, which is a variable applied on the basis of an 8-bit image, is a variable obtained by applying 2 raised to a power of the number of bits constituting a pixel in an image.
